(19) United States
(12) Patent Application Publication
(10) Pub. No.: US 2014/0270654 A1
(43) Pub. Date: Sep. 18, 2014

(54) OPTICAL FIBER ASSEMBLY WITH REPLACEABLE CONNECTING ELEMENT

(71) Applicant: Hon Hai Precision Industry Co., Ltd., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 13/972,868

(22) Filed: Aug. 21, 2013

(30) Foreign Application Priority Data
Mar. 18, 2013 (TW) 102109479

(51) Int. Cl. G02B 6/42

(52) U.S. Cl. CPC G02B 6/4295
USPC 385/89

(57) ABSTRACT

An optical fiber assembly includes two adapters and a connecting element. Each of the adapters includes a connector, a first coupling portion, and a first optical fiber connected between the connector and the first coupling portion. The connecting element includes two second coupling portions and a second optical fiber connected between the two second coupling portions. The second coupling portions are detachably connected to the first coupling portions.

### BACKGROUND

1. Technical Field

The present disclosure relates to optical fiber assemblies, and particularly to an optical fiber assembly with a replaceable connecting element.

2. Description of Related Art

Optical fiber assemblies generally include two connectors and an optical fiber connected between the two connectors. In some applications, the optical fiber may be shorter than required and thus cannot be used. In contrast, in other applications, the optical fiber connector may be greatly longer than required and need to be used with an adaptor, which is inconvenient.

Therefore, it is desirable to provide an optical fiber connector assembly that can overcome the limitations described.

### BRIEF DESCRIPTION OF THE DRAWINGS

FIG. 1 is an isometric view of an optical fiber assembly in accordance with an exemplary embodiment.

FIG. 2 is an isometric view of a connector of an adapter of the optical fiber assembly of FIG. 1.

FIG. 3 is an assemble view of a first coupling portion and a second coupling portion of the optical fiber assembly of FIG. 1.

### DETAILED DESCRIPTION

Embodiments of the disclosure will be described with reference to the drawings.

FIGS. 1-3 show an optical fiber assembly 100 according to an exemplary embodiment. The optical fiber assembly 100 includes two adapters 10 and a connecting element 20 connected between the two adapters 10. In the embodiment, the optical fiber assembly 100 is a USB 3.0 active optical fiber apparatus. The optical fiber assembly 100 includes a number of connecting elements 20 having different length.

Each adapter 10 includes a connector 11, a first coupling portion 12, and a first optical fiber 13 connected between the connector 11 and the first coupling portion 12.

The connector 11 includes a position seat 111, a laser diode 112, a photo diode 113, a circuit board 114, and a number of pins 115. The position seat 111 defines a position hole 116. The first optical fiber 13 is received in the position hole 116. The laser diode 112 and the photo diode 113 are positioned on the position seat 111, and are respectively coupled to the first optical fiber 13. The laser diode 112 converts electronic signals into their corresponding light ray, and the light ray projects into the first optical fiber 13. The photo diode 113 converts received light rays into their corresponding electronic signals. The laser diode 112 and the photo diode 113 are respectively connected to the circuit board 114. The pins 115 are arrayed on the circuit board 114 along one line.

The first coupling portion 12 defines a coupling recess 121 on one end and a first through hole 122 on an opposite end. The first through hole 122 communicates with the coupling recess 121. The first optical fiber 13 is received in the first through hole 122.

The connecting element 20 includes two second coupling portion 21 and a second optical fiber 22 connected between the two second coupling portion 21.

The second coupling portion 21 includes a coupling block 211, a shape of the coupling block 211 is corresponding to a shape of the coupling recess 121. The second coupling portion 21 defines a second through hole 212 penetrating two opposite ends. Two ends of the second optical fiber 22 are respectively received in the two second through holes 212 of the two second coupling portion 21.

The first optical fiber 13 and the second optical fiber 22 are used for transmitting the light rays. The structure of the first optical fiber 13 is the same as the structure of the second optical fiber 22, and is a single mode optical fiber or a multi mode optical fiber.

It should be understood, in order to ensure the alignment between the first optical fiber 13 and the second optical fiber 22, the first coupling portion 12 and the second coupling portion 21 can be designed to other coupling structures. In the embodiment, the first coupling portion 12 and the second coupling portion 21 are made of magnets.

In use, the two second coupling portions 21 of the connecting element 20 are coupled to the two first coupling portions 12 of the two adapters 10. The coupling blocks 211 are received in the coupling recesses 121. The second optical fiber 22 is aligned with the two first optical fibers 13 of the two adapters 10. The electronic signals received by the pins 115 of the adapter 10 are transmitted to the laser diode 112. The laser diode 112 converts the electronic signals to the light rays, and the light rays are emitted to the first optical fiber 13. The light rays are transmitted from the first optical fiber 13 to the second optical fiber 22, and are transmitted from the second optical fiber 22 to the first optical fiber 13 of another adapter 10. The photo diode 113 converts the light rays received from the first optical fiber 13 to the electronic signals, the electronic signals are transmitted to the pins 115 via the circuit board 114.

If the length of the optical fiber assembly 100 is shorter or longer, users depart the two adapters 10 from the connecting element 20. Another connecting element 20 having another length is changed to connect between the two adapters 10. Therefore, the length of the optical fiber assembly 100 is adjusted. As the first coupling portion 12 is coupled to the second coupling portion 21, the adapters 10 can be fast connected or disconnected with the connecting element 20.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical fiber assembly, comprising:
two adapters, each adapter comprising:
a connector comprising a laser diode converting electronic signals into light rays and a photo diode converting the light rays to the electronic signals;
a first coupling portion; and
a first optical fiber connected between the connector and the first coupling portion;
a connecting element, comprising:
two second coupling portions detachably connected to the two first coupling portions of the two adapters; and
a second optical fiber connected between the two second coupling portions;
wherein the light rays emitted from the laser diode of one adapter are transmitted to the photo diode of another adapter via the first optical fiber of one adapter, the second optical fiber, and the first optical fiber of another adapter.

2. The optical fiber assembly of claim 1, wherein the connector comprises a position seat defining a position hole, the first optical fiber is received in the position hole; the laser diode and the photo diode are positioned on the position seat, and are respectively coupled to the first optical fiber.

3. The optical fiber assembly of claim 2, wherein the connector comprises a circuit board and a plurality of pins, the laser diode and the photo diode are respectively connected to the circuit board, the pins are arrayed on the circuit board along one line.

4. The optical fiber assembly of claim 1, wherein the first coupling portion defines a coupling recess on one end and a first thought hole on an opposition end, the first through hole communicates the coupling recess, the first optical fiber is received in the first through hole.

5. The optical fiber assembly of claim 4, wherein the second coupling portion comprises a coupling block, and defines a second through hole penetrating two opposite ends thereof.

6. The optical fiber assembly of claim 5, wherein a shape of the coupling block is corresponding to a shape of the coupling recess, and the coupling block is received in the coupling recess.

7. An optical fiber assembly, comprising:
two adapters, each of the adapters comprising a connector, a first coupling portion, and a first optical fiber connected between the connector and the first coupling portion; and
a connecting element comprising two second coupling portions and a second optical fiber connected between the two second coupling portions;
wherein each of the second coupling portions is detachably connected to a respective one of the first coupling portions.
